(19) United States
(12) Patent Application Publication
(10) Pub. No.: US 2021/0169745 A1
(43) Pub. Date: Jun. 10, 2021

(54) FLEXIBLE PACIFIER

(71) Applicants: Nouri Edward Hakim, Monroe, LA (US); Jacob Max Sclare, Calhoun, LA (US)

(72) Inventors: Nouri Edward Hakim, Monroe, LA (US); Jacob Max Sclare, Calhoun, LA (US)

(21) Appl. No.: 16/708,662

(22) Filed: Dec. 10, 2019

(51) Int. Cl. A61J 17/00

(52) U.S. Cl. CPC A61J 17/008

(57) ABSTRACT

The present invention is directed to a pacifier. The pacifier of the invention includes a baglet and a shield. The baglet has a tip, a shaft and base. The tip has a length and width that is greater than the length and width of the shaft. The base is adapted to connect the baglet to the shield and has creases configured to permit the baglet to move toward and away from the shield and rotate about a center point of the base.

This application claims the benefit of U.S. provisional patent application Ser. No. 62/902,108, filed Sep. 18, 2019, which is incorporated herein by reference in its entirety.

### FIELD OF THE DISCLOSURE

The present disclosure relates generally to pacifiers and, more particularly, to a flexible pacifier.

### BACKGROUND

Pacifiers are provided to satisfy an infants need to suck. Generally, pacifiers are made to resemble the human nipple and generally include a baglet or nipple, a shield and a handle. Numerous designs for the baglet, shield and handle are known. While many designs resemble human anatomy, the fact the pacifiers are constructed of synthetic materials limits the ability of the pacifier to perform like a human nipple. Accordingly, there is a need to improve the pacifier so that it performs more ergonomically.

### SUMMARY

The present invention is directed to a pacifier. The pacifier of the invention includes a baglet and a shield. The baglet has a tip, a shaft and base. The base is adapted to connect the baglet to the shield and has at least one crease configured to permit the baglet to move toward and away from the shield and rotate about a center point of the base. In another embodiment, the shield further comprises a rim constructed of a material having a hardness greater than the shield. In another embodiment, the baglet and shield are constructed of silicone. In another embodiment, the baglet and shield are constructed of silicone having a durometer between shore 35 and 55. In another embodiment, the shield has a rim constructed of a material having a durometer of between shore 45 and 80. In another embodiment, the pacifier further comprises a plurality of creases. In another embodiment, the crease in the base forms a hinge with the shield. In another embodiment, the height of the baglet is no more than two times a diameter of the base.

In another embodiment, a pacifier comprises a baglet having a tip, a shaft and base and a shield having a rim. The tip being non-symmetrical and having a length and width that is greater than the length and width of the shaft. The base is adapted to connect the baglet to the shield and has a crease configured to permit the baglet to move toward and away from the shield and rotate about a center point of the base. In another embodiment, the baglet and shield are constructed of silicone. In another embodiment, the baglet and shield are constructed of silicone having a durometer between shore 35 and 55. In another embodiment, the baglet rotates relative to the shield.

In another embodiment, the pacifier comprises a baglet having a tip, a shaft and base and a shield having a rim. The tip and shaft are non-symmetrical. The tip has a length and width that is greater than the length and width of the shaft. The base is adapted to connect the baglet to the shield and has a plurality of creases configured to permit the baglet to move toward and away from the shield and rotate about a center point of the base. In another embodiment, the tip has an oval cross-section. In another embodiment, the baglet has a cross-section having a length and width that are greater than a length and width of a cross-section of the shaft. In another embodiment, the baglet has a height that is two times a diameter of the base. In another embodiment, the creases have a diameter greater than a diameter of the shaft. In another embodiment, the shield has a rim. In another embodiment, the shield has a rim having a greater durometer than the durometer of the shield.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a rear perspective view of one embodiment of the present invention;

FIG. 2 is a front perspective view of one embodiment of the present invention;

FIG. 3 is a front plan view of an embodiment of the present invention;

FIG. 4 is a rear plan view of an embodiment of the present invention;

FIG. 5 is a left plan view of an embodiment of the present invention;

FIG. 6 is a right plan view (mirror of the left) of an embodiment of the present invention;

FIG. 7 is a top plan view of an embodiment of the present invention;

FIG. 8 is a bottom plan view of an embodiment of the present invention;

FIG. 9 is a cross-section view of the line 9-9 in FIG. 3; and

FIG. 10 is a cross-section view of the line 10-10 in FIG. 3.

### DETAILED DESCRIPTION OF THE EMBODIMENTS

Reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

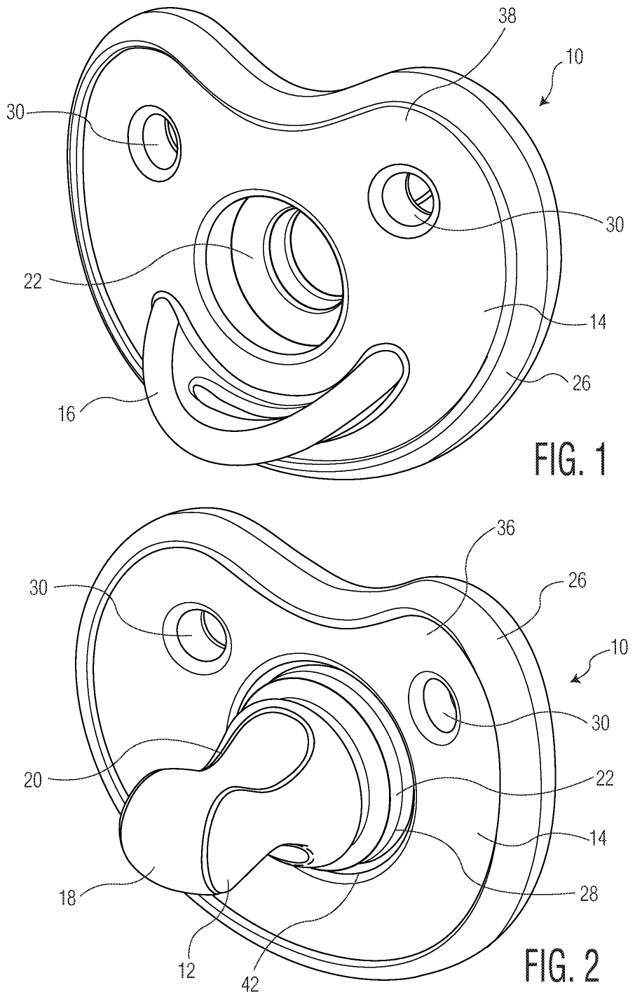

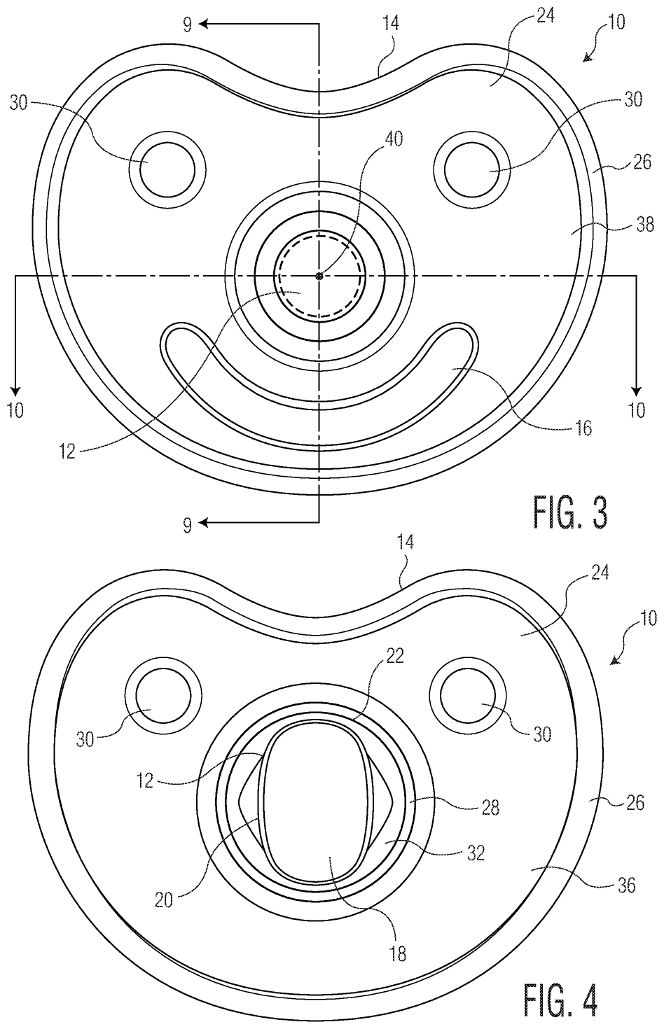

Referring now to FIGS. 1 and 2, respectively rear and front perspective views of one embodiment of the present invention, pacifier 10 is shown. Pacifier 10 includes baglet or nipple 12, shield 14 and handle 16. Baglet 12 is further comprised of tip 18, shaft 20 and base 22. Shield 14 is further comprised of plate 24 and rim 26. Plate 24 has front surface 36 that is adjacent the baby's face when in use and a back surface 38 that is opposite front surface 36. Base 22 further comprises at least one crease 28. Base 22 is adapted to connect the nipple 12 to the shield 14 and has at least one crease 28 configured to permit the nipple 12 to move toward and away from the shield 14 and rotate about a center point 40 (FIG. 3) of the base 22. Base 22 also includes hinge 42 that aids in the articulation provided by crease 28. In an alternative embodiment, a plurality of creases 28 may be provided. Shield 14 includes openings 30, also known as ventilation holes that permit the flow of air to the front surface 36. In the preferred embodiment, nipple 12 and plate 24 are constructed of a soft, flexible material such as silicone having a durometer measurement of between shore 25 and 55, preferably shore 45. In the preferred embodiment, rim 26 is preferably formed of a harder material typically having a durometer measurement in the range of shore 55 to 85, preferably shore 80. Rim 26 can be over molded onto shield 14 as is well known to those skilled in the art. The crease 28 in base 22 permit nipple 12 to articulate in multiple directions about fixed center point 40. For example, creases 28 permit nipple 12 to not only move toward and away from front surface 36 of shield 14, they also permit nipple 12 to move horizontally.

Referring now to FIGS. 3 and 4, respectively front and rear plan views of an embodiment of the present invention, pacifier 10 is described in more detail. Nipple 12 is shown in the middle of plate 24 of shield 14. Nipple 12 is preferably non-symmetrical where the tip 18 has a length and width that is greater than the length and width of shaft 20. It should be understood, however, that a symmetrical or round nipple 12 is within the scope of the invention. Plate 24 is shown with openings 30 and rim 26 along the outer perimeter of plate 24 forming the outer edge of shield 14. Fixed to shield 14 is handle 16. While the particular shape shown for handle 16 is considered preferable, any suitable shape of handle 16 is within the scope of the invention. Nipple 12 is shown with tip 18 in the form of an oval. At the foot 32 of shaft 20 base 22 with creases 28 is fixed to plate 24 of shield 14. Base 22 is adapted to connect nipple 12 to shield 14 and crease 28 is configured to permit nipple 12 to move toward and away from shield 14 and rotate about center point 40. In a preferred embodiment, the height of nipple 12 is at least two times the diameter of the base. In the preferred embodiment, the crease 28 has a diameter that is greater than the diameter of shaft 20. The particular profile or shape of crease 28 is not functional and other profiles or shapes are within the scope of this invention.

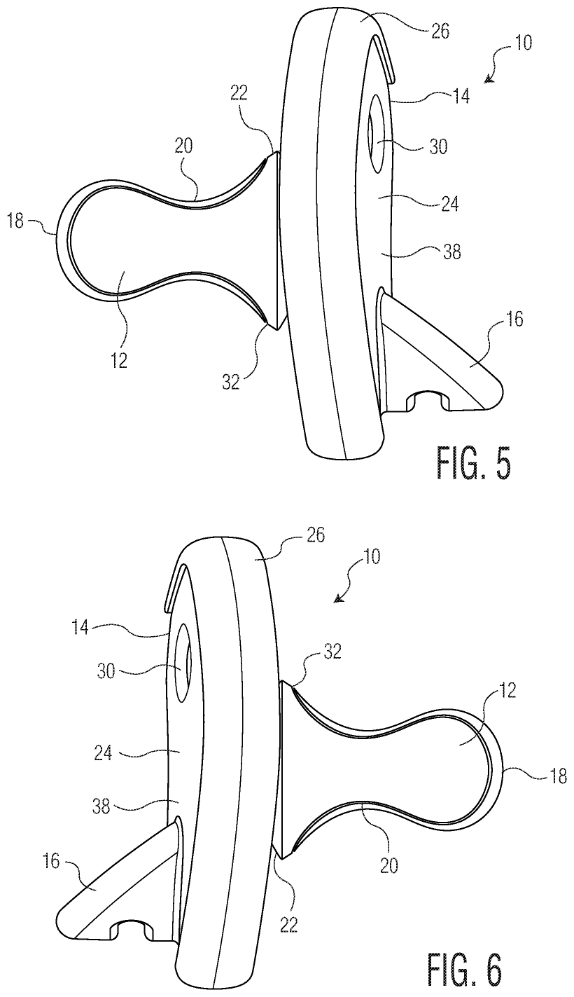

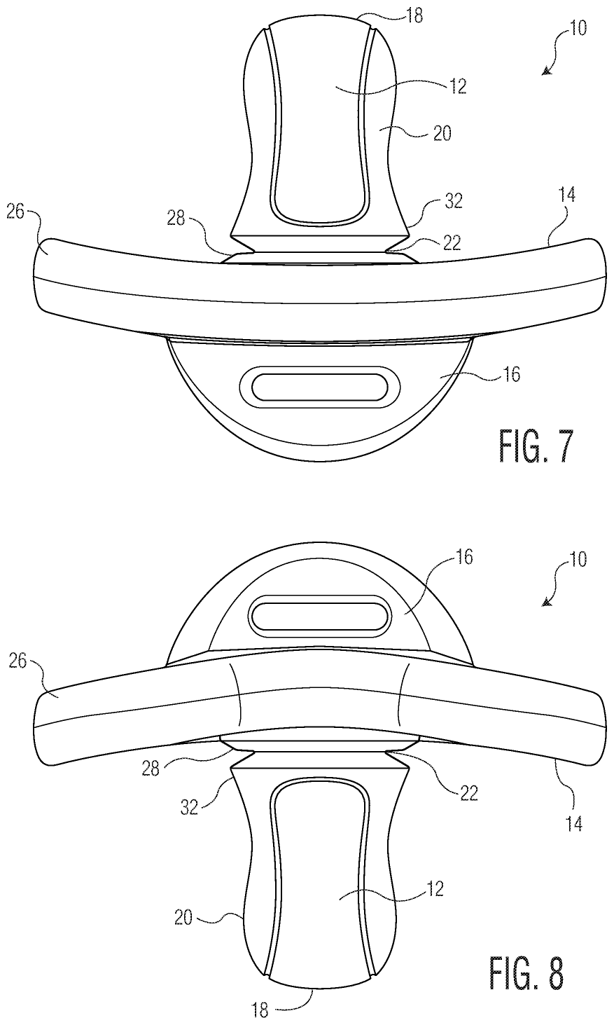

Referring now to FIGS. 5-8, respectively left and right plan views, and top and bottom plan views of an embodiment of the present invention, shows in more detail the shapes and contours of nipple 12. The tip 18 of nipple 12 is broadened to more closely resemble the human nipple but then narrows at shaft 20 then broadens at foot 32. This shape permits the nipple to occupy the child's mouth while allowing the lips and gums to grip the pacifier 10 at shaft 20 and the broadened foot 32, along with shield 14, restrains the pacifier from being sucked too far into the child's mouth. In the preferred embodiment, the height of nipple 12 is at least two times the diameter of base 22. The creases 28 impart a high degree of flexibility to nipple 12. The creases 28 not only permit nipple 12 to move toward and away from shield 14 more than a conventional pacifier, they also impart multiple degrees of freedom along the plane of the shield 14.

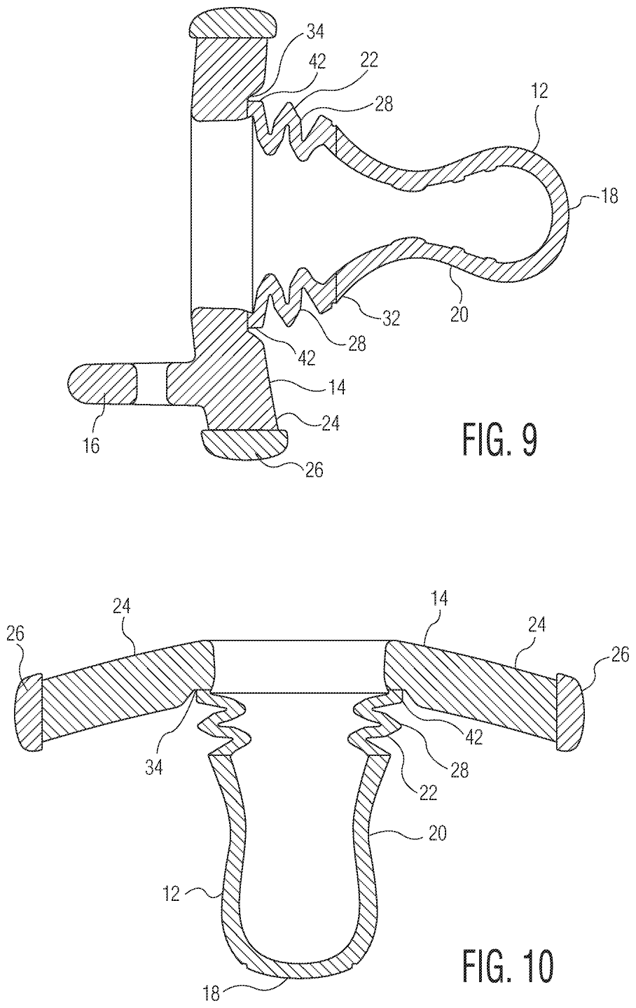

Referring now to FIGS. 9 and 10, respectively cross-section views along the lines 9-9 and 10-10 in FIG. 3, specific details of nipple 12 and in particular creases 28 are described. Tip 18 of nipple 12 is shown with two different cross-sections consistent with the oval shape of the preferred embodiment. Similarly, shaft 20 is also shown with two different cross-sections. At the bottom of shaft 20 is foot 32 connecting shaft 20 to base 22. Base 22 attaches to shield 14 at joint 34. Creases 28 of base 22 are shown forming an accordion shape however other shapes are within the scope of this invention. The creases 28 permit nipple 12 to move both longitudinally and horizontally providing a high degree of flexibility. Shield 14 is shown with plate 24 and rim 26. In the preferred embodiment, handle 16 is constructed of the same material as plate 24 and nipple 12.

Although exemplary embodiments have been shown and described, it will be clear to those of ordinary skill in the art that a number of changes, modifications, or alterations to the disclosure as described may be made. All such changes, modifications, and alterations should therefore be seen as within the scope of the disclosure.

What is claimed is:

1: A pacifier comprising:
A baglet and a shield;
The baglet having a tip, a shaft and base;
The base adapted to connect the baglet to the shield and having at least one crease configured to permit the baglet to move toward and away from the shield and rotate about a center point of the base.

2: The pacifier 1 of claim 1, further comprising a handle attached to the shield.

3: The pacifier of claim 1, wherein the shield further comprises a rim constructed of a material having a hardness greater than the shield.

4: The pacifier of claim 1, wherein the baglet and shield are constructed of silicone.

5: The pacifier of claim 1, wherein the baglet and shield are constructed of silicone having a durometer between 35 and 55.

6: The pacifier of claim 1, wherein the shield has a rim constructed of a material having a durometer of between 45 and 80.

7: The pacifier of claim 1, further comprising a plurality of creases.

8: The pacifier of claim 1, wherein the crease in the base forms a hinge with the shield.

9: The pacifier of claim 1, wherein the height of the baglet is no more than two times a diameter of the base.

10: A pacifier comprising:
A baglet having a tip, a shaft and base and a shield having a rim;
The tip being non-symmetrical and having a length and width that is greater than the length and width of the shaft;
The base adapted to connect the baglet to the shield and having a crease configured to permit the baglet to move toward and away from the shield and rotate about a center point of the base.

11. The pacifier of claim 10, wherein the baglet and shield are constructed of silicone.

12: The pacifier of claim 10, wherein the baglet and shield are constructed of silicone having a durometer between 35 and 55.

13: The pacifier of claim 10, wherein the baglet rotates relative to the shield.

14: A pacifier comprising:
A baglet having a tip, a shaft and base and a shield having a rim;
The tip and shaft being non-symmetrical;
The tip having a length and width that is greater than the length and width of the shaft;
The base adapted to connect the baglet to the shield and having a plurality of creases configured to permit the baglet to move toward and away from the shield and rotate about a center point of the base.

15: The pacifier of claim 14, wherein the tip has an oval cross-section.

16: The pacifier of claim 14, wherein the baglet has a cross-section having a length and width that are greater than a length and width of a cross-section of the shaft.

17: The pacifier of claim 14, wherein the baglet has a height that is at least two times a diameter of the base.

18: The pacifier of claim 14, wherein the creases have a diameter greater than a diameter of the shaft.

19: The pacifier of claim 14, wherein the shield has a rim.

20: The pacifier of claim 14, wherein the shield has a rim having a greater durometer than the durometer of the shield.
